(19) United States
(12) Patent Application Publication
(10) Pub. No.: US 2008/0017149 A1
(43) Pub. Date: Jan. 24, 2008

(54) Phase angle detection device and internal combustion engine valve timing control apparatus using the same

(75) Inventors: Naoki Kokubo, Kanagawa (JP); Yoshiyuki Kobayashi, Kanagawa (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 11/826,605

(22) Filed: Jul. 17, 2007

(30) Foreign Application Priority Data
Jul. 21, 2006 (JP) 2006-198828

(51) Int. Cl. F01L 1/34; G01M 15/04

(52) U.S. Cl. 123/90.16; 73/116

(57) ABSTRACT

A phase angle detection device includes a crank-angle detecting element for detecting a rotational position of a crankshaft through a predetermined crank target, a cam target fixedly connected to a camshaft and having a first detecting section whose detected position continuously changes and at least one second detecting section whose detected position discontinuously changes, and a cam-angle detecting element for detecting a displacement of the cam target. Also provided is a controller configured to adequately update a phase difference of the camshaft relative to the crankshaft through all engine operating conditions, utilizing interpolation based on an analogue sensor signal generated by the first and second detecting sections and/or a rate of change in the sensor signal generated by the first detecting section.

### TECHNICAL FIELD

The present invention relates to a phase angle detection device configured to detect a rotational phase difference between at least two rotation axes, and specifically to a phase angle detection device for use in an internal combustion engine valve timing control apparatus configured to variably control engine valve timings, for example, intake valve closure timing (IVC) and intake valve open timing (IVO), and/or exhaust valve closure timing (EVC) and exhaust valve open timing (EVO), depending on engine operating conditions.

### BACKGROUND ART

In recent years, there have been proposed and developed various phase angle detection devices suitable for variable valve timing control (VTC) systems of internal combustion engines. One such phase angle detection device has been disclosed in Japanese Patent Provisional Publication No. 6-299876 (hereinafter is referred to as “JP6-299876”). In JP6-299876, the phase-angle-detector equipped variable valve timing control system is exemplified in the VTC device installed on the intake valve side. The VTC system includes a phase-change mechanism configured to variably adjust engine valve timings (IVO and IVC) by changing a relative phase of a camshaft to an engine crankshaft depending on engine operating conditions, such as engine speed and/or engine load, and a phase angle detection device configured to detect a relative-rotation phase difference of the camshaft to the crankshaft and to output a drive signal (a feedback signal based on the detected relative-rotation phase difference and its desired value) to the phase-change mechanism.

The phase-angle detection device is comprised of a crank-angle sensor (or a crankshaft position sensor) that detects a rotation angle of the crankshaft, a cam-angle sensor (or a camshaft position sensor) that detects a rotation angle of the camshaft, and a controller configured to detect, based on sensor signals from these sensors, a relative-rotation phase difference between the crankshaft and the camshaft.

There are various rotation-angle sensors suitable to each of the crank-angle sensor and the cam-angle sensor, for example, an electromagnetic pickup type, a magneto-resistive element type, an optical element type, and the like.

### SUMMARY OF THE INVENTION

Assuming that an electromagnetic pickup rotation-angle sensor is used as a crank-angle sensor, generally, the pickup type crank-angle sensor is comprised of a substantially disk-shaped crank target installed on an engine crankshaft and having a plurality of target protrusions (just like external teeth) formed on an outer periphery, and a crank-angle detecting element configured to detect a rotational position and rotation speed of the crankshaft by picking up the plurality of target protrusions and to generate the detected signal to a controller. In a similar manner, assuming that an electromagnetic pickup rotation-angle sensor is used as a cam-angle sensor, for instance, the pickup type cam-angle sensor is comprised of three target protrusions installed on a camshaft and circumferentially equidistant-spaced from each other, and a cam-angle detecting element located in close proximity to the camshaft and configured to detect a rotational position of the camshaft by picking up each of the three target protrusions and to generate the detected signal to the controller.

Hereunder described is one method to detect a relative-rotation phase difference of the camshaft to the crankshaft. Regarding a crank-angle pulse signal generated from the crank-angle sensor, for instance, suppose that one pulse signal per 10° crankangle (CA) is generated and additionally a missing external-toothed portion (i.e., a missing target protrusion) is provided for every 120° CA so as to generate a crank-angle sensor signal (e.g., a zero or no pulse signal output) corresponding to the missing toothed portion for every 120° CA. The crank-angle sensor signal output corresponding to the missing toothed portion, which signal is generated for every 120° CA, serves as a crank-angle base position (simply, a crank-angle base). On the other hand, regarding a cam-angle pulse signal generated from the cam-angle sensor, suppose that one pulse signal per 120° cam-angle is generated owing to the angle (i.e., 120 degrees) between two adjacent target protrusions of the three target protrusions installed on the camshaft and circumferentially equidistant-spaced from each other. The cam-angle sensor signal output corresponding to each of the three target protrusions, which signal output is generated for every 120° cam-angle (corresponding to every 240° crankangle, because of one revolution of the camshaft for each two revolutions of the crankshaft), serves as a cam-angle base position (simply, a cam-angle base). Thus, the cam-angle base position (the cam-angle base) is updated only once for every 240° CA. By comparing the timing (generally expressed in terms of crank angle), at which the previously-noted cam-angle base has been detected, to the previously-noted crank-angle base, a cam phase angle (in other words, a relative-rotation phase difference of the camshaft to the crankshaft) can be calculated. More concretely, a reference cam-angle base (generated with no phase change) is calculated based on the detected crank-angle base, and then a deviation of the detected cam-angle base from the calculated reference cam-angle base is calculated. The deviation is determined as a cam phase angle (in other words, a relative-rotation phase difference of the camshaft to the crankshaft). For example, when the actually-detected cam-angle base is phase-advanced 60 degrees as compared to the reference cam-angle base, the controller determines that a relative-rotation phase of the camshaft to the crankshaft is phase-advanced 60 degrees.

However, in the case of the previously-discussed relative-rotation phase difference detection method, the cam-angle base signal is generated from the cam-angle detecting element in the form of a cam-angle pulse signal output for every 120° cam-angle (in other words, for every 240° CA). The cam-angle base signal is obtained by picking up the circumferentially equidistant-spaced, discontinuous, three target protrusions. Thus, during mid-speed or high-speed operation at engine speeds of 120° rpm or more, it is possible to provide a comparatively high accuracy of phase-angle detection. In contrast, during very low speed operation at engine speeds ranging from 200 rpm to 400 rpm, such as during cranking, owing to three circumferential clearances, each of which is defined between two adjacent target protrusions of the circumferentially equidistant-spaced, discontinuous, three target protrusions, the phase-angle update frequency with respect to the VTC system control execution cycle (sampling time interval) tends to reduce, thus deteriorating the accuracy of phase-angle detection. That is to say, it is impossible to ensure a high accuracy of phase-angle detection through all engine operating conditions.

Accordingly, it is an object of the invention to provide a phase angle detection device and an internal combustion engine valve timing control apparatus using the same, which enables a high accuracy of phase-angle detection through all engine operating conditions, ranging from very low speed operation to high speed operation.

In order to accomplish the aforementioned and other objects of the present invention, a phase angle detection device comprises a drive-shaft angle detecting element configured to detect a rotational position of a drive shaft through a predetermined drive-shaft target, a driven-shaft target fixedly connected to a driven shaft driven by the drive shaft, and having a first detecting section whose detected position continuously changes and at least one second detecting section whose detected position discontinuously changes, the second detecting section being formed at one end of the first detecting section, and a driven-shaft angle detecting element configured to detect a displacement of the driven-shaft target, wherein the phase angle detection device detects a rotation angle of the driven shaft based on an output signal from the driven-shaft angle detecting element, and detects a rotation angle of the drive shaft based on an output signal from the drive-shaft angle detecting element, and detects a phase angle of the driven shaft relative to the drive shaft based on the detected rotation angle of the driven shaft and the detected rotation angle of the drive shaft.

According to another aspect of the invention, a phase angle detection device comprises a drive-shaft angle detecting element configured to detect a rotational position of a drive shaft through a predetermined drive-shaft target, a driven-shaft target fixedly connected to a driven shaft driven by the drive shaft, and having a first detecting section whose detected position continuously changes and at least one second detecting section whose detected position discontinuously changes, the second detecting section being formed at one end of the first detecting section, a driven-shaft angle detecting element configured to detect a displacement of the driven-shaft target, and a controller configured to detect a rotation angle of the driven shaft based on an output signal from the driven-shaft angle detecting element, and to detect a rotation angle of the drive shaft based on an output signal from the drive-shaft angle detecting element, and to detect a phase angle of the driven shaft relative to the drive shaft based on the detected rotation angle of the driven shaft and the detected rotation angle of the drive shaft.

According to a further aspect of the invention, an internal combustion engine valve timing control apparatus employing a phase-change mechanism for variably adjusting engine valve timing by changing a relative-rotation phase between a camshaft and a crankshaft depending on an engine operating condition, and a controller configured to detect a relative-rotation phase difference between the camshaft and the crankshaft and to output a drive signal based on the detected phase difference to the phase-change mechanism, the valve timing control apparatus comprising a crank-angle detecting element configured to detect a rotational position of the crankshaft through a predetermined crank target, a cam target fixedly connected to the camshaft driven by the crankshaft, and having a first detecting section whose detected position continuously changes and at least one second detecting section whose detected position discontinuously changes, the second detecting section being formed at one end of the first detecting section, and a cam-angle detecting element configured to detect a displacement of the cam target, wherein the controller is configured to detect a rotation angle of the camshaft based on an output signal from the cam-angle detecting element, and to detect a rotation angle of the crankshaft based on an output signal from the crank-angle detecting element, and to detect a phase angle of the camshaft relative to the crankshaft based on the detected rotation angle of the camshaft and the detected rotation angle of the crankshaft.

According to a still further aspect of the invention, an internal combustion engine valve timing control apparatus comprises a crank-angle detecting element configured to detect a rotational position of a crankshaft through a predetermined crank target, a cam target fixedly connected to a camshaft driven by the crankshaft, and having a first detecting section whose detected position continuously changes and at least one second detecting section whose detected position discontinuously changes, the second detecting section being formed at one end of the first detecting section, a cam-angle detecting element configured to detect a displacement of the cam target, a controller configured to detect a rotation angle of the camshaft based on an output signal from the cam-angle detecting element, and to detect a rotation angle of the crankshaft based on an output signal from the crank-angle detecting element, and to detect a phase angle of the camshaft relative to the crankshaft based on the detected rotation angle of the camshaft and the detected rotation angle of the crankshaft, and a phase-change mechanism for changing the phase angle of the camshaft relative to the crankshaft in response to a control signal generated from the controller and determined based on the detected phase angle.

The other objects and features of this invention will become understood from the following description with reference to the accompanying drawings.

### BRIEF DESCRIPTION OF THE DRAWINGS

FIG. 1 is a schematic system diagram illustrating an internal combustion engine valve timing control apparatus to which a phase angle detection device of an embodiment is applicable.

FIG. 2 is an elevation view illustrating a crank target of a crank-angle sensor constructing a part of the phase angle detection device of the embodiment.

FIG. 3 is an elevation view illustrating a cam target of a cam-angle sensor constructing a part of the phase angle detection device of the embodiment.

FIG. 4 is a perspective view illustrating a modified cam target.

FIG. 5 is a signal output characteristic diagram illustrating a crank-angle pulse signal (crank pulses) and a cam-angle sensor signal, respectively generated from the crank-angle sensor and the cam-angle sensor included in the phase angle detection device of the embodiment.

FIG. 6 is a flow chart illustrating a phase-angle detection routine executed within a controller incorporated in the phase angle detection device of the embodiment.

FIG. 7 is a partially enlarged, signal output characteristic diagram illustrating a crank-angle pulse signal and a cam-angle sensor signal V both produced according to the phase-angle detection routine of FIG. 6, utilizing a crank rotation angle “interpolation” timer.

FIG. 8 is a flow chart illustrating a first modified phase-angle detection routine, utilizing a gradient ΔV (per 10° CA) of cam-angle sensor signal output V.

FIG. 9 is a partially enlarged, signal output characteristic diagram illustrating a crank-angle pulse signal and a cam-angle sensor signal both produced according to the 1^{st} modified phase-angle detection routine of FIG. 8.

FIG. 10A is a signal output characteristic diagram illustrating cam-angle sensor signal waveforms produced according to the 1^{st} modified phase-angle detection routine of FIG. 8, during a non-phase-change period (a phase-angle hold mode), during a phase-advance period, and during a phase-retard period.

FIG. 10B is a waveform characteristic diagram illustrating the detected signal waveform of the cam phase angle obtained according to the 1^{st} modified phase-angle detection routine of FIG. 8, during the non-phase-change period (at the phase-angle hold mode), during the phase-advance period, and during the phase-retard period.

FIG. 11 is a step-response waveform diagram illustrating a step-response waveform obtained by the use of the phase-angle detection routine of FIG. 6 or by the use of the first modified phase-angle detection routine of FIG. 8, during engine cranking.

FIG. 12 is a flow chart illustrating a second modified phase-angle detection routine.

FIG. 13 is a flow chart illustrating a third modified phase-angle detection routine.

FIG. 14 is a flow chart illustrating a fourth modified phase-angle detection routine.

### DESCRIPTION OF THE PREFERRED EMBODIMENTS

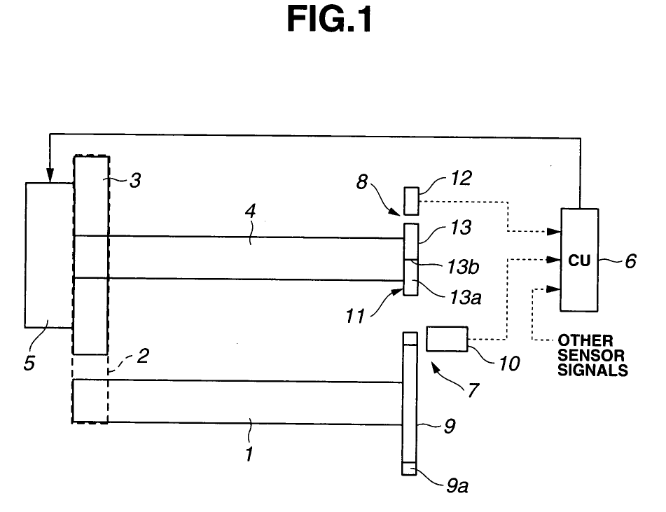

Referring now to the drawings, particularly to FIG. 1, the phase angle detection device of the embodiment is exemplified in a variable valve timing control (VTC) system of an internal combustion engine. For the purpose of simplification of the disclosure, in the shown embodiment, the phase angle detection device is applied to only an intake-side valve actuating system. As a matter of course, the phase angle detection device of the embodiment may be applied to an exhaust-side valve actuating system.

The VTC system shown in FIG. 1 uses a so-called electromagnetic-brake valve timing control device as disclosed in Japanese Patent Provisional Publication No. 2005-180307, corresponding to U.S. Pat. No. 7,143,730. The electromagnetic-brake valve timing control device itself is conventional, typical details of such electromagnetic-brake VTC device being set forth in U.S. Pat. No. 7,143,730 issued Dec. 5, 2006 to Atsushi Yamanaka and assigned to the assignee of the present invention, the teachings of which are hereby incorporated by reference. Thus, only the schematic construction of the VTC system employing such an electromagnetic-brake VTC device is hereunder described briefly.

That is, the VTC system is comprised of at least a timing sprocket 3, a camshaft 4, a sleeve (not shown) fixedly connected to one axial end of camshaft 4, and a phase-change mechanism 5. Torque is transmitted from an engine crankshaft 1, serving as a drive shaft, via a chain 2 to timing sprocket 3. Camshaft 4, serving as a driven shaft, is rotatably supported, such that relative rotation of camshaft 4 to timing sprocket 3 is permitted within a predetermined angular range. Phase-change mechanism 5 is provided between timing sprocket 3 and the sleeve fixedly connected to camshaft 4, for changing a relative-rotation phase of camshaft 4 to timing sprocket 3 (i.e., crankshaft 1), depending on engine operating conditions.

Phase-change mechanism 5 includes a substantially elliptic radial guide window or a substantially elliptic radial guide groove (simply, a radial guide) formed in timing sprocket 3, a spiral guide (a spiral groove) formed in a spiral disk, a link member, an engagement portion (concretely, an engagement pin), and a hysteresis brake serving as an electromagnetic brake. The base end of the link member is pivotably linked to the aforementioned sleeve, whereas the distal end of the link member is in cam-connection with the radial guide such that the distal end is radially movable along the radial guide. The distal end of the link member is also formed with an engagement-pin accommodation hole (or an engagement-pin retaining bore). The previously-noted engagement pin is retained within the engagement-pin accommodation hole of the link-member distal end, while a substantially semi-spherical portion of the engagement pin is in engagement with the spiral guide. The hysteresis brake (the electromagnetic brake) is activated or energized in response to a control signal generated from an electronic control unit (CU) or a controller 6 (described later) appropriately depending on engine operating conditions, so as to apply a braking force to the spiral disk. More concretely, the electromagnetic braking action (the actuating force) is supplied to the spiral disk through a material displaying hysteresis by a control current generated from controller 6 and flowing through an electromagnetic coil of the hysteresis brake. By way of the electromagnetic braking action, the engagement pin slides along the spiral guide, while radially moving along the radial guide. This permits rotation of the above-mentioned sleeve (in other words, camshaft 4) relative to timing sprocket 3 within the predetermined angular range, thereby enabling variable control for engine valve timings of the intake-side valve actuating system, that is, intake valve open timing (IVO) and intake valve closure timing (IVC).

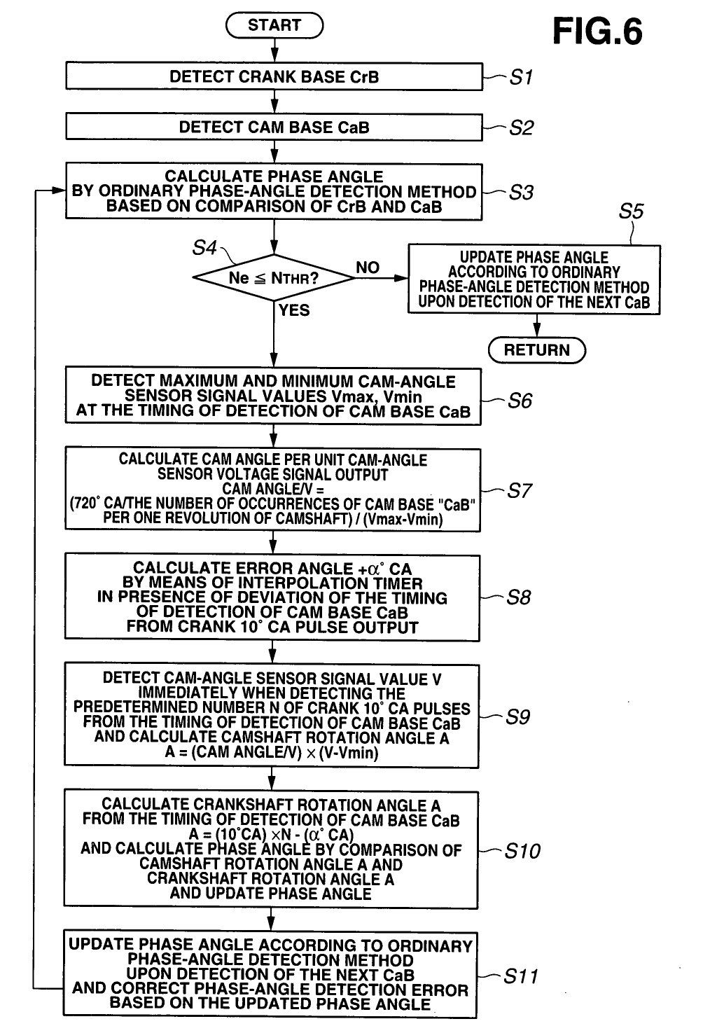

Controller 6 generally comprises a microcomputer. Controller 6 includes an input/output interface (I/O), memories (RAM, ROM), and a microprocessor or a central processing unit (CPU). The input/output interface (I/O) of controller 6 receives input information from various engine/vehicle sensors, namely a crank-angle sensor 7, an intake-air quantity detector such as an airflow meter (not shown), an engine temperature detector (for example, an engine coolant temperature sensor, a lubricating oil temperature sensor, and the like), an accelerator opening detector such as an accelerator-pedal angular position sensor (or a throttle opening sensor), and a cam-angle sensor 8. Within controller 6, the central processing unit (CPU) allows the access by the I/O interface of input informational data signals from the previously-discussed engine/vehicle sensors. The CPU of controller 6 is responsible for carrying the control program (the phase-angle detection routine described later in reference to each of the flow charts shown in FIGS. 6, 8 and 12-14) stored in memories and is capable of performing necessary arithmetic and logic operations. Computational results (arithmetic calculation results), that is, a calculated output signal is relayed through the output interface circuitry of controller 6 to output stages, namely the electromagnetic coil of the hysteresis brake (the electromagnetic actuator) of phase-change mechanism 5 included in the VTC system employing the phase angle detection device of the embodiment.

Actually, controller 6 is configured to detect or estimate or determine an engine operating condition (at the current VTC system control execution cycle) based on latest up-to-date informational data signals from crank-angle sensor 7, the intake-air quantity detector, the engine temperature detector, and the accelerator opening detector. Crank-angle sensor 7 is provided to detect a rotational position (i.e., a rotation angle) and rotation speed of crankshaft 1, that is, engine speed Ne. Cam-angle sensor 8 is provided to detect a rotational position of camshaft 4. As described later in detail, controller 6 is also configured to detect or estimate or determine a relative-rotation phase angle of camshaft 4 to crankshaft 1 based on latest up-to-date informational data signals from crank-angle sensor 7 and cam-angle sensor 8, so as to drive phase-change mechanism 5 responsively to a feedback control signal determined based on a deviation (an error signal) of the detected relative-rotation phase angle from its desired value based on the current engine operating condition.

In more detail, in the shown embodiment, an electromagnetic pickup rotation-angle sensor is used as the crank-angle sensor 7. As seen in FIG. 1, crank-angle sensor 7 (electromagnetic pickup rotation-angle sensor) is constructed by a substantially disk-shaped, thin-walled crank target 9 bolted to the rear end of crankshaft 1 and a crank-angle detecting element 10 serving as a pulse generator. Crank target 9 has a plurality of crank-target protrusions 9a formed on its circumference and serving as pulse inducing portions. Crank-angle detecting element 10 is provided for detecting up-to-date information concerning the rotational position (rotation angle) and rotation speed of crankshaft 1 by picking up the plurality of crank-target protrusions 9a.

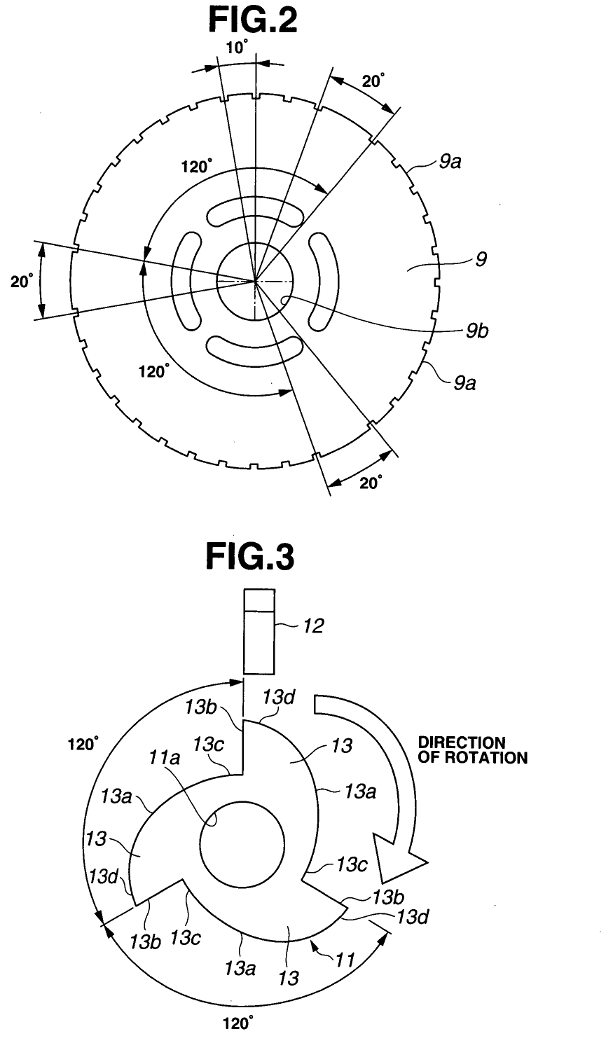

Referring to FIG. 2, there is shown the detailed configuration of crank target 9. As seen in FIG. 2, crank target 9 is formed as a substantially disk-shaped thin-walled component part having a predetermined diameter. The disk-shaped crank target 9 is formed with a central through hole serving as a bolt insertion hole 9b. As previously described, the disk-shaped crank target 9 is formed on its circumference with the plurality of crank-target protrusions 9a. Actually, the plurality of crank-target protrusions 9a are formed by intermittently forming a plurality of small rectangular notched portions in the circumference of the disk-shaped crank target. As clearly shown in FIG. 2, almost all of the rectangular notched portions are circumferentially equidistant-spaced from each other at an equal distance, in other words, at an equal circular pitch of 10° crankangle (CA), but a missing rectangular notched portion (in other words, a missing toothed portion) is provided for every 120° CA. Thus, three of the plurality of crank-target protrusions 9a, circumferentially 120°-spaced from each other, are formed as comparatively wide crank-target protrusions, each having a circumferential width substantially corresponding to 20° CA. Each of the remaining crank-target protrusions has a circumferential width substantially corresponding to 10° CA.

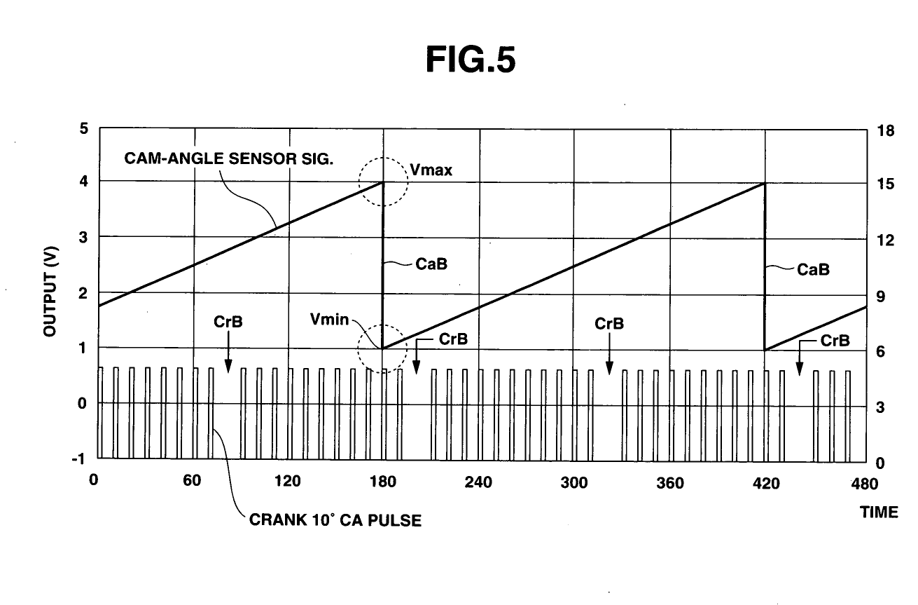

Crank-angle detecting element 10 is fixedly connected to an engine rocker cover (not shown) and located in close proximity to the circumference of crank target 9 in the axial direction of crankshaft 1, for picking up crank-target protrusions 9a, and for generating a so-called crank 10° CA pulse signal (see FIG. 5), produced due to each of the comparatively narrow crank-target protrusions 9a having a circumferential width substantially corresponding to 10° CA, and for generating a crank-angle sensor signal corresponding to each of the three missing rectangular notched portions (that is, each of the three circumferentially wide crank-target protrusions 120°-spaced from each other and having a circumferential width substantially corresponding to 20° CA) As can be seen from the signal output characteristic diagram of FIG. 5, actually, the crank-angle sensor signal, corresponding to each of the three circumferentially wide crank-target protrusions (each of the three missing toothed portions), is produced in the form of a zero or no pulse signal output. The crank-angle sensor signal output (a zero or no pulse signal output) corresponding to the missing toothed portion (the wide crank-target protrusion having a circumferential width substantially corresponding to 20° CA), which signal is generated for every 120° CA, functions as a crank-angle base position (simply, a crank-angle base or a crank base denoted by “CrB”). As discussed previously, in the shown embodiment, an electromagnetic pickup rotation-angle sensor is used as the crank-angle sensor 7. In lieu thereof, crank-angle sensor 7 may be constructed by the other type of rotation-angle sensor, such as a magneto-resistive element type (e.g., a Hall-effect device that operates on the Hall-effect principle) or an optical element type.

On the other hand, cam-angle sensor 8 is installed on the rear end of camshaft 4 by means of bolts (see FIG. 1). Cam-angle sensor 8 is constructed by a cam target 11 bolted to the rear end of camshaft 4 and a cam-angle detecting element 12. Cam target 11 is formed as a compound-leaf shaped thin-walled component part integrally formed with circumferentially equidistant-spaced, radially-extending (radially-protruding) three target portions 13. Cam-angle detecting element 12 is a gap sensor for detecting a displacement of each of circumferentially equidistant-spaced target portions 13.

Referring now to FIG. 3, there is shown the detailed configuration of cam target 11. As seen in FIG. 3, cam target 11 is formed with a central through hole serving as a bolt insertion hole 11a. Cam target 11 is formed integral with the previously-noted circumferentially equidistant-spaced spaced three target portions 13, 13, 13, each extending radially from the central bolt insertion hole 11a. Notice that, in the phase angle detection device of the embodiment, each of circumferentially equidistant-spaced three target portions 13 has a first detecting section 13a having a continuous arc-shaped curve, and a second detecting section 13b cut-out radially inwards from the radial outermost end of 1^{st} detecting section 13a. As can be appreciated from the elevation view of FIG. 3, the circumference of 1^{st} detecting section 13a is circumferentially curved forwards with respect to the direction of rotation of camshaft 4 and formed into a circular-arc shape.

As previously discussed, 1^{st} detecting section 13a of each of circumferentially equidistant-spaced three target portions 13 is configured or formed into a circular-arc shape, such that the radius of curvature of the circular-arc shaped 1^{st} detecting section 13a gradually increases from a first end portion (i.e., its radially inward end 13c) to a second end portion (i.e., its radially outward end 13d), and that a detected position of 1^{st} detecting section 13a, to be detected by cam-angle detecting element 12, continuously changes. On the other hand, 2^{nd} detecting section 13b of each of circumferentially equidistant-spaced three target portions 13 is configured or formed as a radial cutout that radially extends in the direction perpendicular to the axis of camshaft 4 from the radially outward end 13d of 1^{st} detecting section 13a toward the center of bolt insertion hole 11a, and whereby a detected position of 2^{nd} detecting section 13b to be detected by cam-angle detecting element 12 discontinuously changes.

Cam-angle detecting element 12 is an electromagnetic pickup rotation-angle sensor. Cam-angle detecting element 12 is fixedly connected to the engine rocker cover and located in close proximity to the rear end of camshaft 4, such that cam-angle detecting element 12 is arranged in the radial direction of camshaft 4 in a manner so as to be directed to 1^{st} and 2^{nd} detecting sections 13a-13b of cam target 11 in the radial direction of camshaft 4. As seen from the signal output characteristic diagram of FIG. 5, cam-angle detecting element 12 basically generates a continuous saw-tooth-waveform signal (or a continuous stepwise voltage signal in the form of an analogue signal) by detecting 1^{st} and 2^{nd} detecting sections 13a-13b of cam target 11. As can be seen from the cam-angle sensor signal waveform (the saw-tooth-waveform) of FIG. 5, a signal section corresponding to the circular-arc shaped 1^{st} detecting section 13a is detected as a continuous up-sloped signal portion of the saw-tooth-waveform. On the other hand, a signal section corresponding to 2^{nd} detecting section 13b is detected as a discontinuous trailing-edge signal portion, which is cyclically produced thrice for each one revolution of camshaft 4. In FIG. 5, the left-hand side axis of ordinate indicates a cam-angle sensor voltage signal output (unit: volts), whereas the right-hand side axis of ordinate indicates a crank-angle sensor pulse signal output (unit: volts).

A position at which a rapid change (i.e., a rapid fall) in the signal output level of cam-angle detecting element 12 occurs, in other words, an angular position corresponding to the discontinuous trailing-edge signal portion detected due to 2^{nd} detecting section 13b can be accurately detected or determined by monitoring the cam-angle sensor signal waveform detected by cam-angle detecting element 12. The angular position corresponding to the discontinuous trailing-edge signal portion, which signal portion is produced for every 120° cam-angle (i.e., for every 240° CA, because of one revolution of camshaft 4 for each two revolutions of crankshaft 1), functions as a cam-angle base position (simply, a cam-angle base or a cam base denoted by “CaB”). A maximum signal value Vmax and a minimum signal value Vmin of the sensor signal generated from cam-angle detecting element 12 vary or fluctuate depending on engine operating conditions. Fully taking account of a change in each of maximum and minimum signal values Vmax and Vmin both varying depending on engine operating conditions, maximum and minimum signal values Vmax and vmin (see the signal portions surrounded by the upper and lower small circles indicated by the broken line in FIG. 5) are modified appropriately by way of learning control, each time the previously-noted cam base “CaB” is detected. In lieu thereof, the maximum cam-sensor signal value Vmax may be modified or updated to an arithmetic average value (a simple average) of the previous values of maximum cam-sensor signal value Vmax detected during a time period corresponding to the predetermined number of revolutions of engine crankshaft 1, while the minimum cam-sensor signal value Vmin may be modified or updated to an arithmetic average value (a simple average) of the previous values of minimum cam-sensor signal value Vmin detected during a time period corresponding to the predetermined number of revolutions of engine crankshaft 1. Alternatively, the maximum cam-sensor signal value Vmax may be modified or updated to a simple average of a predetermined number of previous values of maximum cam-sensor signal value Vmax detected before the current control execution cycle, while the minimum cam-sensor signal value Vmin may be modified or updated to a simple average of a predetermined number of previous values of minimum cam-sensor signal value Vmin detected before the current execution cycle.

Hereunder described in detail is a concrete method to convert the saw-tooth signal (cam-angle sensor voltage signal output V) produced by 1^{st} and 2^{nd} detecting sections 13a-13b of cam target 11 into a cam angle of camshaft 4. As previously discussed, a discontinuous trailing-edge signal portion, corresponding to cam base “CaB”, is produced three times for each one revolution of camshaft 4. Thus, a conversion rate (Cam angle/V), exactly, a camshaft rotation angle (a cam angle of camshaft 4) per a unit cam-angle sensor voltage signal output, is calculated or determined from the following conversion expression.

Cam angle/V=(720° CA/the number of occurrences of cam base “CaB” per one revolution of camshaft)/(Vmax-Vmin) Assuming that V denotes a detected cam-angle sensor voltage signal output, maximum cam-sensor signal value Vmax is equal to 4V (4 volts), and minimum cam-sensor signal value Vmin is equal to 1V (1 volt), the aforementioned conversion expression is represented by the following approximate expression.

Cam angle/V=(720° CA/3)/(4V−1V)=240° CA/3V=80° CA/V

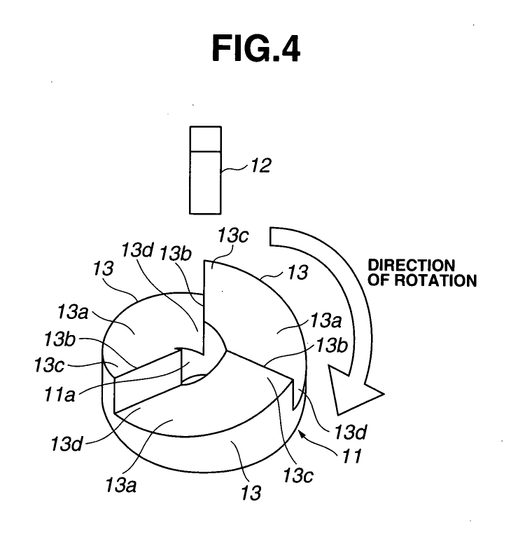

Referring now to FIG. 4, there is shown the modification of cam target 11. The modified cam target 11 of FIG. 4 is formed as a three-dimensional component part integrally formed with axially-ridged three target portions 13 and also formed with a central through hole (bolt insertion hole 11a). As seen in FIG. 4, three target portions 13 are integrally formed with each other around the bolt insertion hole 11a and circumferentially arranged at an equal interval. Each of three target portions 13, 13, 13 has a first detecting section 13a having a curved axial end face and a second detecting section 13b shaped into an axially-ridged portion. The axial end face of 1^{st} detecting section 13a is circular-arc shaped in the circumferential direction (see the curved axial end face down-sloped in the direction of rotation of camshaft 4 in FIG. 4). 2^{nd} detecting section 13b is shaped to be linearly ridged or risen from the axial outermost end of 1^{st} detecting section 13a in the radial direction as well as the axial direction. 1^{st} detecting section 13a of each of circumferentially equidistant-laid-out three target portions 13 is formed as a down-sloped curved surface having a predetermined down grade (or a predetermined down-slope angle) and down-sloping from the first end portion 13c, whose tip is identical to the associated 2^{nd} detecting section 13b, to the second end portion (the axially-recessed portion) 13d. Thus, 1^{st} detecting section 13a is configured such that a detected position of 1^{st} detecting section 13a of the three-dimensional modified cam target 11 of FIG. 4, to be detected by cam-angle detecting element 12, continuously changes. On the other hand, 2^{nd} detecting section 13b is formed as a radially-steeply-risen portion having a flat surface extending axially from the first end portion 13c of 1^{st} detecting section 13a, and whereby a detected position of 2^{nd} detecting section 13b to be detected by cam-angle detecting element 12 discontinuously changes. Additionally, cam-angle detecting element 12 is fixedly connected to the engine rocker cover and located in close proximity to the rear end of camshaft 4, such that cam-angle detecting element 12 is arranged in the axial direction of camshaft 4 in a manner so as to be directed to 1st and 2^{nd} detecting sections 13a-13b of the three-dimensional modified cam target 11 in the axial direction of camshaft 4.

For the sake of simplicity in the following discussion, a method of detection of cam phase angle is explained in cam target 11, which is formed as a compound-leaf shaped thin-walled component part formed integral with circumferentially equidistant-spaced, radially-extending three target portions 13 as shown in FIG. 3. It will be appreciated that the invention is not limited to such a compound-leaf shaped cam target, but that a three-dimensional modified cam target as shown in FIG. 4 may be used, since the three-dimensional modified cam target of FIG. 4 can provide the same operation and effect as the compound-leaf shaped cam target of FIG. 3. The compound-leaf shaped cam target of FIG. 3 is superior to the three-dimensional modified cam target of FIG. 4, in simple shape and easy productivity or easy but high-precision machining work. In contrast to the above, the three-dimensional modified cam target of FIG. 4 is superior to the compound-leaf shaped cam target of FIG. 3, in reduced radial dimension. The three-dimensional modified cam target of FIG. 4 having the reduced radial dimension enhances the degree of freedom of layout in installing the phase angle detection device itself and/or the phase-angle-detector equipped VTC apparatus on the engine, while effectively suppressing the radial size.

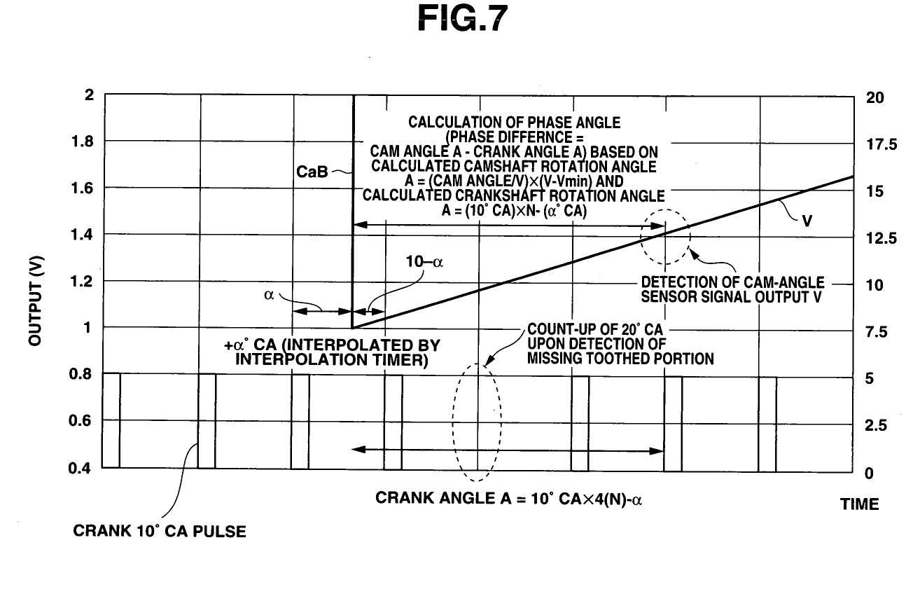

Referring now to FIG. 6, there is shown the cam-phase-angle detection routine executed within controller 6. Concretely, the phase-angle detection method (the cam-phase-angle detection routine) of FIG. 6, in particular, a method of finding an approximation for a cam angle, for a given number N of crank pulses, somewhere between a timing of detection of the first cam base CaB and a timing of detection of the next cam base CaB, is based on “interpolation” illustrated by the partially enlarged, signal output characteristic diagram in FIG. 7. The phase-angle detection routine shown in FIG. 6 is executed as time-triggered interrupt routines to be triggered every predetermined sampling time intervals Tcon, such as 10 milliseconds.

At step S1 of FIG. 6, a crank-angle base position (i.e., crank base CrB) is detected by means of crank-angle sensor 7.

At step S2, a cam-angle base position (i.e., cam base CaB) is detected by means of cam-angle sensor 8.

At step S3, a cam phase angle (a relative-rotation phase difference of camshaft 4 to crankshaft 1) is detected or calculated by way of an ordinary phase-angle detection method that a cam phase angle is calculated based on the result of comparison of cam base CaB detected through step S2 and crank base CrB, which crank base CrB is detected through step S1 and specifies a reference cam base with no phase change.

At step S4, a check is made to determine whether engine speed Ne is less than or equal to a specified engine speed (that is, a predetermined engine speed threshold value N_{THR}). When the answer to step S4 is in the negative (NO), that is, Ne>N_{THR}, the routine proceeds from step S4 to step S5. Conversely when the answer to step S4 is in the affirmative (YES), that is, Ne≦N_{THR}, the routine proceeds from step S4 to step S6.

At step S5, according to the ordinary cam-phase-angle detection method (that is, the phase-angle detection method based on CaB-CrB comparison), the cam phase angle is updated at the timing of detection of the next cam base CaB, and thereafter the program returns to step S1.

Note that, according to the phase angle detection device of the embodiment, in the case of Ne≦N_{THR}, a cam phase angle (a relative-rotation phase difference of camshaft 4 to crankshaft 1) is detected or calculated by way of an improved cam-phase-angle detection method (utilizing a crank rotation angle “interpolation” timer) as defined by a series of steps S6-S10.

At step S6, the processor of controller 6 detects maximum and minimum sensor signal values Vmax and Vmin (see FIG. 5) of the cam-angle sensor voltage signal output from cam-angle sensor 8 at the timing of detection of cam base CaB, which cam base CaB has been detected through step S2 at the current execution cycle of the arithmetic and logic program (the phase-angle detection routine of FIG. 6).

At step S7, a cam angle of camshaft 4 per a variation of the cam-angle sensor voltage signal output, in other words, a conversion rate (Cam angle/v), exactly, a camshaft rotation angle per a unit cam-angle sensor voltage signal output, is arithmetically calculated from the previously-discussed conversion expression, that is, (Cam angle/V) =(720° CA/the number of occurrences of cam base “CaB” per one revolution of camshaft)/(Vmax-Vmin).

At step S8, when there is a deviation (+α° CA) of the timing (in terms of crankangle) of detection of cam base CaB from a crank 10° CA pulse signal output, that is, when the timing of detection of cam base CaB after the crank 10° CA pulse signal output is represented by an angle of 10 degrees of crankangle (10° CA) plus something extra, that is, 10° CA +α° CA, this extra angle (+α° CA) is calculated by means of a crank rotation angle “interpolation” timer. This is because a detected timing of leading edge (rising edge) of a crank 10° CA pulse (or a detected timing of trailing edge (falling edge) of the crank 10° CA pulse) and a timing of detection of cam base CaB are not always identical to each other, owing to an installation error of crank-angle sensor 7 and/or cam-angle sensor 8, and as a result the previously-discussed error angle “+α° CA” occurs. As can be seen from FIG. 7, the error angle “+α° CA”, occurring due to the installation error, can be calculated by means of the “interpolation” timer.

At step S9, immediately when detecting the predetermined number N of crank 10° CA pulses from the timing of detection of cam base CaB, the cam-angle sensor voltage signal output V is detected and additionally a camshaft rotation angle (a cam angle A) from the detected cam base CaB is arithmetically calculated from the following expression. Note that the crank-angle sensor signal output (a zero or no pulse signal output) corresponding to the missing toothed portion (the wide crank-target protrusion having a circumferential width substantially corresponding to 20° CA) is also counted or regarded as one of the predetermined number N of crank 10° CA pulses.

Cam angle A=(Cam angle/V)×(V-Vmin)

where (Cam angle/V) denotes a conversion rate, exactly, a camshaft rotation angle per a unit cam-angle sensor voltage signal output, and the conversion rate (Cam angle/V) is 80° CA on the assumption that maximum cam-sensor signal value Vmax is equal to 4V (4 volts) and minimum cam-sensor signal value Vmin is equal to 1V (1 volt).

At step S10, immediately when detecting the predetermined number N of crank 10° CA pulses from the timing of detection of cam base CaB, a rotation angle (a crank angle A) of crankshaft 1 from the detected cam base CaB is arithmetically calculated from the following expression.

Crank angle A=(10° CA)×N−(α° CA)

where N denotes the predetermined number of crank 10° CA pulses, and α denotes the installation error angle occurring owing to an installation error of crank-angle sensor 7 and/or cam-angle sensor 8. Additionally, at step S10, a phase angle (i.e., a phase difference of camshaft 4 relative to crankshaft 1) is calculated by comparing the calculated crank angle A {=(10° CA)×N−(α° CA)} to the calculated cam angle A (=(Cam angle/V)×(V-Vmin)) obtained through step S9. The comparison result (the computational result) denoted by a positive sign “+”, i.e., the positive phase difference of camshaft 4 to crankshaft 1 means a phase advance. In contrast, the comparison result denoted by a minus sign “−”, i.e., the negative phase difference of camshaft 4 to crankshaft 1 means a phase retard. Informational data concerning a phase difference (or a cam phase angle) is updated by the newly calculated phase angle.

For instance, assuming that the timing of detection of cam base CaB is deviated from the timing of detection of crank 10° CA pulse output by α=8° CA during the phase-angle hold mode and the predetermined number N of crank 10° CA pulses detected and counted from the timing of detection of cam base CaB is set to “4”, the rotation angle of crankshaft 1 (i.e., crank angle A) is calculated as 32° CA from the expression A=(10° CA)×4−(8° CA)=32° CA. On the other hand, the rotation angle of camshaft 4 (i.e., cam angle A) is calculated as 32° CA from the expression A=(80° CA)×(1.4−1)=32° CA, because of the cam-angle sensor signal output V=1.4 volts at the phase-angle hold mode (see FIG. 7). Thus, the difference (Cam angle A−Crank angle A=32° CA−32° CA) becomes 0° CA. In this case, the rotation angle of crankshaft 1 becomes identical to the rotation angle of camshaft 4, and thus the phase difference of camshaft 4 relative to crankshaft 1 becomes 0° CA.

At step S11, when the next cam base CaB is detected, informational data concerning the phase difference (or the cam phase angle) is updated according to the ordinary cam-phase-angle detection method (that is, the phase-angle detection method based on CaB-CrB comparison). At the same time, a phase-angle detection error is corrected based on the updated phase angle. Thereafter, the routine returns from step S11 to step S3. A series of steps S6-S10 (that is, the cam-phase-angle detection method utilizing the “interpolation” timer) are repeatedly executed under the condition of Ne≦N_{THR}, until the next cam base CaB is detected.

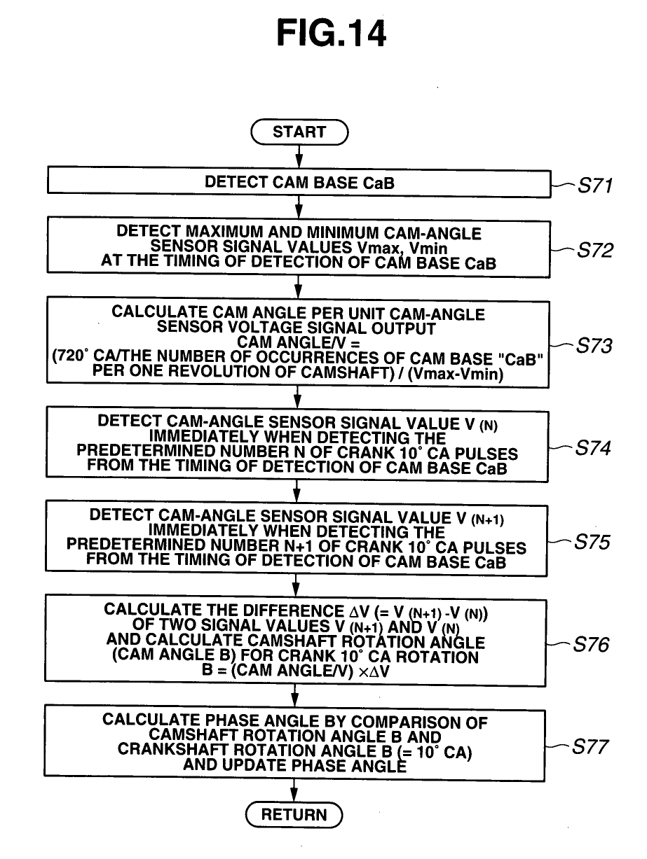

The previously-discussed predetermined number N (needed for steps S74-S75 of FIG. 14) of crank 10° CA pulses is obtained by the inequality 1>N>(720° CA/the number of occurrences of cam base “CaB” per one revolution of camshaft)/(10° CA)−1. In the shown embodiment, the number of occurrences of cam base “CaB” per one revolution of camshaft is “3”, and therefore the predetermined number N is set within the specified range of 1≦N≦23.

As set forth above, according to the phase angle detection device of the embodiment explained in reference to FIGS. 1-7, it is possible to detect a cam-target signal, which signal is produced by the 1^{st} detecting section 13a of cam target portion 13 and changeable continuously in the form of an analogue signal, while detecting and utilizing a crank 10° CA pulse signal serving as a reference (REF) of a minimum detection cycle. Even when the number of revolutions of crankshaft 1 is low, for example, even during very low speed operation at engine speeds ranging from 200 rpm to 400 rpm, such as during cranking, it is possible to remarkably enhance the detection frequency of a relative-rotation phase difference of camshaft 4 to crankshaft 1, thus avoiding the accuracy of detection of cam phase angle from being undesirably affected by positive and negative fluctuations in rotation speed of crankshaft 1. That is, it is possible to more precisely detect the relative-rotation phase difference between camshaft 4 and crankshaft 1.

As a result, it is possible to enhance the operational responsiveness of phase-change mechanism 5, thereby quickly achieving optimal valve timings even when cranking and starting a cold engine or even during idling. This contributes to reduced exhaust emissions during engine start-up, improved fuel economy, stable idling speeds, and enhanced vehicle's ability to accelerate during the vehicle starting period.

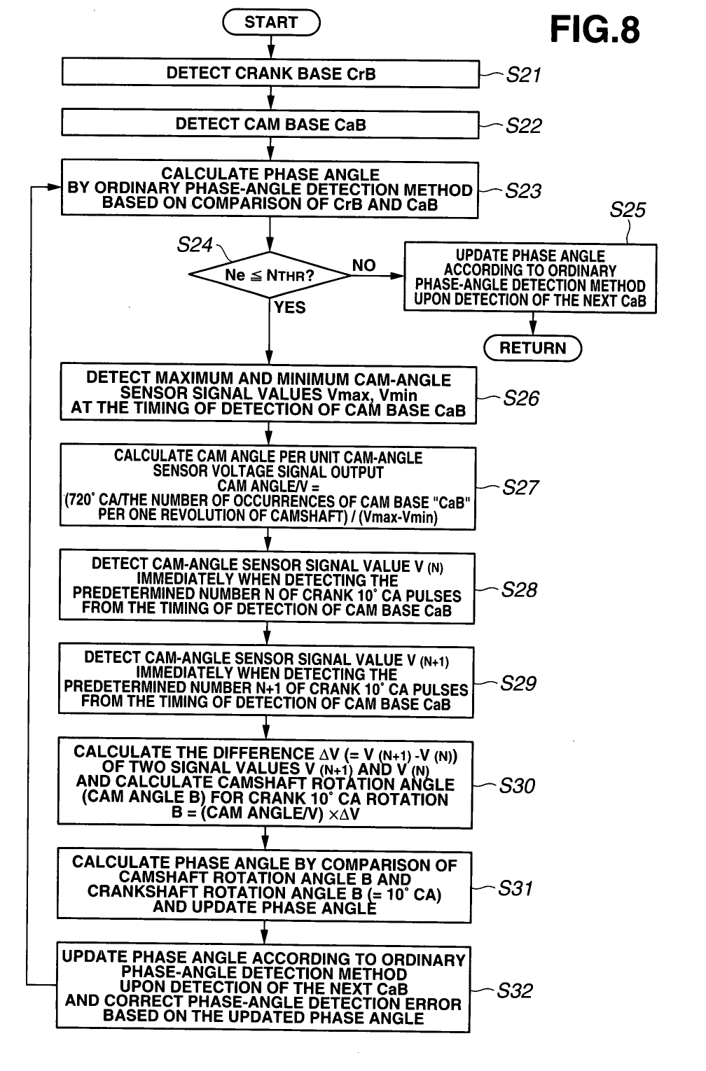

Referring now to FIG. 8, there is shown the 1^{st} modified phase-angle detection routine. The 1^{st} modified phase-angle detection routine of FIG. 8 is also executed as time-triggered interrupt routines to be triggered every predetermined sampling time intervals, such as 10 milliseconds. The 1^{st} modified phase-angle detection routine of FIG. 8 is similar to the arithmetic and logic processing of FIG. 6, except that, in the 1^{st} modified phase-angle detection routine of FIG. 8, a gradient ΔV (described later) of a detected value of cam angle (that is, cam-angle sensor voltage signal output V), detected through 1^{st} detecting section 13a of cam target portion 13, is utilized for detection of the phase difference. For this reason, steps S8-S10 included in the routine shown in FIG. 6 are replaced with steps S28-S31 included in the routine shown in FIG. 8. Steps S21-S27 and S32 of the 1^{st} modified routine of FIG. 8 are equal to respective steps S1-S7 and S11 of the routine of FIG. 6. Only the different steps S28-S31 of FIG. 8 will be hereinafter described in detail with reference to the accompanying drawings, while detailed description of steps S21-S27 will be omitted because the above description thereon seems to be self-explanatory.

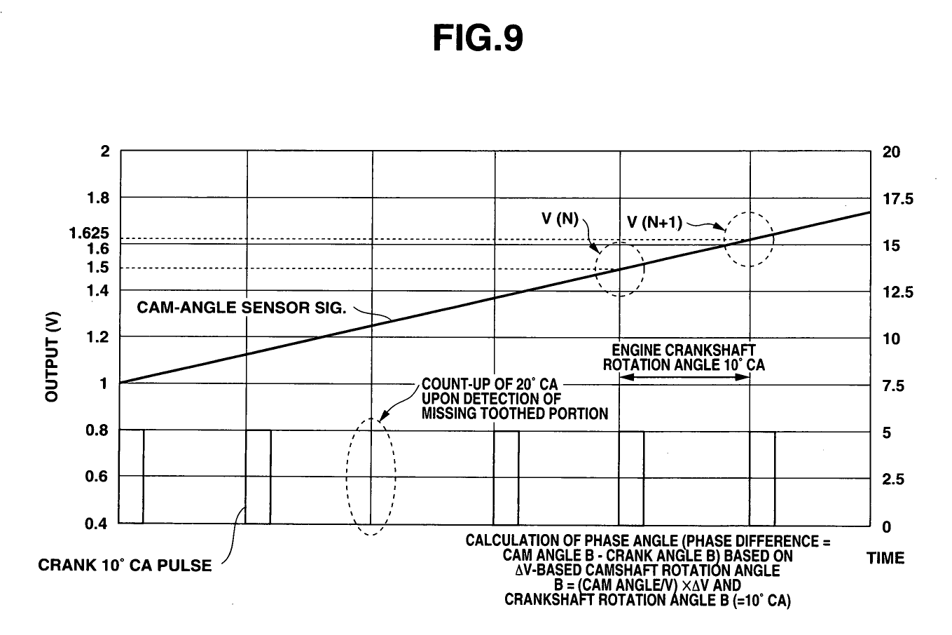

At step S28 of FIG. 8, immediately when detecting the predetermined number N of crank 10° CA pulses from the timing of detection of cam base CaB, a cam-angle sensor signal value V_{(N)} is detected. At this stage, the cam-angle sensor voltage signal output V_{(N)} is merely detected and memorized (see FIG. 9).

At step S29, immediately when detecting the predetermined number N+l of crank 10° CA pulses from the timing of detection of cam base CaB, a cam-angle sensor signal value V(N+1) is detected.

At step S30, the difference ΔV (=V_{(N+1)}−V_{(N)}) of these two signal values V_{(N+1)} and V_{(N)} is arithmetically calculated, and additionally a camshaft rotation angle (a cam angle B) for crank 10° CA rotation is arithmetically calculated from the following expression.

Cam angle B=(Cam angle/V)×(V_{(N+1)}−V_{(N)})=(Cam angle/V)×ΔV

At step S31, a rotation angle of crankshaft 1 (a crank angle B) from the timing of detection of the consecutive crank 10° CA pulses of the predetermined number N to the timing of detection of the consecutive crank 10° CA pulses of the predetermined number N+l is always set to 10° CA, because of (N+1)−N=1, that is, an increase in only one 10° CA pulse output that means 10° CA rotation. Additionally, at step S31, a phase angle (i.e., a phase difference of camshaft 4 relative to crankshaft 1) is calculated by comparing the crank angle B {=10° CA} to the calculated cam angle B (=(Cam angle/V)×ΔV)) obtained through step S30, that is, by subtracting the crank angle B {=10° CA} from the calculated cam angle B (=(Cam angle/V)×ΔV)). The comparison result (the computational result) denoted by a positive sign “+”, i.e., the positive phase difference of camshaft 4 to crankshaft 1 means a phase advance. In contrast, the comparison result denoted by a minus sign “−” i.e., the negative phase difference of camshaft 4 to crankshaft 1 means a phase retard. Informational data concerning a phase difference (or a cam phase angle) is updated by the newly calculated phase angle.

For instance, assuming that the cam-angle sensor signal output value V_{(N)} is 1.5 volts and the cam-angle sensor signal output value V_{(N+1)} is 1.625 volts during the phase-angle hold mode, the voltage difference (or the gradient or the rate of change in the cam-angle sensor analogue signal) ΔV for crank 10° CA rotation (in other words, for an increase in only one crank 100 pulse signal output) becomes 0.125 volts. Thus, the rotation angle of camshaft 4 (i.e., cam angle B) is calculated as 10° CA from the expression B=(80° CA)×(1.625−1.5)=(80° CA)×(0.125)=10° CA. On the other hand, the rotation angle of crankshaft 1 (i.e., crank angle B) is set to 10° CA. Thus, the difference (Cam angle B−Crank angle B=10° CA−10° CA) becomes 0° CA. In this case, the rotation angle of crankshaft 1 becomes identical to the rotation angle of camshaft 4, and thus the phase difference of camshaft 4 relative to crankshaft 1 becomes 0° CA.

At step S32, when the next cam base CaB is detected, informational data concerning the phase difference (or the cam phase angle) is updated according to the ordinary cam-phase-angle detection method (that is, the phase-angle detection method based on CaB-CrB comparison). At the same time, a phase-angle detection error is corrected based on the updated phase angle. Thereafter, the routine returns from step S32 to step S23. A series of steps S26-S31, included in the 1^{st} modified cam-phase-angle detection method utilizing gradient ΔV (per 10° CA) of cam-angle sensor signal output V, are repeatedly executed under the condition of Ne≦N_{THR}, until the next cam base CaB is detected.

According to the 1^{st} modified phase-angle detection routine of FIGS. 8-9, the gradient (the voltage difference) ΔV of the detected value of cam angle (i.e., cam-angle sensor analogue signal output V) can be arithmetically calculated for every 100 crankangle. Thus, it is possible to enhance the accuracy of cam-phase-angle detection (the accuracy of phase-difference detection), however, there is no output of phase-difference informational data, when detecting a crank 10° CA pulse signal output just after the timing of detection of cam base CaB. For this reason, if controller 6 has an adequate processing capacity, the previously-discussed cam-phase-angle detection method, utilizing the crank rotation angle “interpolation” timer, may be used in combination, only when detecting the crank 10° CA pulse signal output just after the timing of detection of cam base CaB. This further improve the accuracy of detection of cam phase angle.

The previously-discussed predetermined number N (needed for steps S28-S29 of FIG. 8) of crank 10° CA pulses is obtained by the inequality 1≦N≦(720° CA/the number of occurrences of cam base “CaB” per one revolution of camshaft)/(10° CA)−1. In the shown embodiment, the number of occurrences of cam base “CaB” per one revolution of camshaft is “3”, and therefore the predetermined number N is set within the specified range of 1≦N≦23.

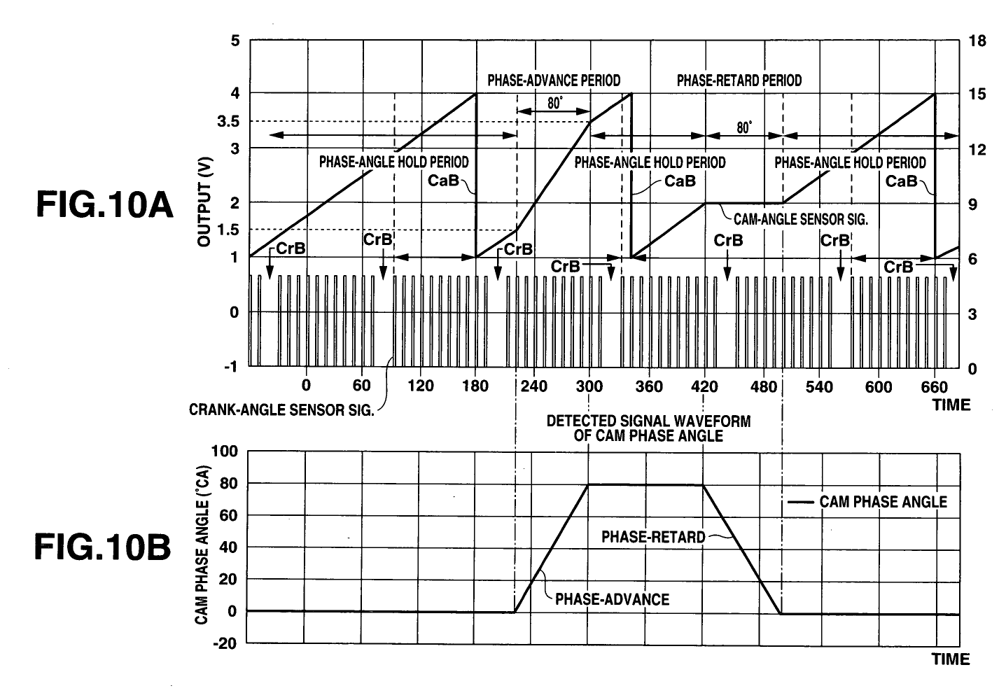

Referring now to FIGS. 10A-10B, there are shown the cam-angle sensor signal waveforms produced according to the 1^{st} modified phase-angle detection routine of FIG. 8, and the cam-phase-angle change, at three different cam-phase modes, namely, at the phase-angle hold mode, at the phase-advance mode, and at the phase-retard mode. For the sake of simplicity, these characteristics of FIGS. 10A-10B are illustrated or based on the assumption that the VTC is maintained at the phase-angle hold mode within the first 240° crankangle range, and phase-advanced within the second 240° crankangle range, and then phase-retarded within the third 240° crankangle range.

As can be seen from the up-sloped characteristic of the cam-angle sensor voltage signal output V within the first 240° crankangle range during the phase-angle hold mode, a gradient of cam-angle sensor voltage signal output V is represented by 4V/240° CA=0.0125V/1° CA=0.125V/10° CA. Thus, cam angle B is calculated as 10° CA from the expression Cam angle B=(Cam angle/V)XΔV=(80° CA/V)×(0.125V)=10° CA (per 10° crankangle), because of Cam angle/V=80° CA/V. That is, during the phase-hold mode, the gradient (the voltage difference) ΔV updated for every 10° crankangle is fixed to 0.125V/10° CA, and thus the difference (Cam angle B−Crank angle B=10° CA−10° CA) becomes 0° CA, and as a result the phase difference of camshaft 4 relative to crankshaft 1 also becomes 0° CA.

As can be seen from the polygonal up-sloped characteristic of the cam-angle sensor voltage signal output V within the second 240° crankangle range during the phase-angle advance mode, a gradient of cam-angle sensor voltage signal output V is represented by (3.5V−1.5V)/80° CA=2V/80° CA=0.025V/1° CA=0.25V/10° CA. Thus, cam angle B is calculated as 20° CA from the expression Cam angle B=(Cam angle/V)×ΔV=(80° CA/V)×(0.25V)=20° CA (per 10° crankangle), because of Cam angle/V=80°0 CA/V. That is, during the phase-advance mode, the gradient (the voltage difference) ΔV updated for every 10° crankangle is set to 0.25V/10° CA, and thus the difference (Cam angle B−Crank angle B=20° CA−10° CA) becomes +10° CA (per 10° crankangle), and the phase difference of camshaft 4 relative to crankshaft 1 also becomes +10° CA (per 10° crankangle). As a result, the cam phase angle becomes advanced by +10° CA (per 10° crankangle). As clearly shown in FIG. 10A, the phase-advance state is continuously detected for the time interval corresponding to the eight consecutive crank 10° CA pulses, and thus the phase-advance angle of the VTC device becomes (+10° CA)×8=+80° CA.

In contrast, as can be seen from the horizontally-extending characteristic line of the cam-angle sensor voltage signal output V within the third 240° crankangle range during the phase-angle retard mode, a gradient of cam-angle sensor voltage signal output V is represented by (2V−2V)/80° CA=0V/80° CA=0V/10° CA. Thus, cam angle B is calculated as 0° CA from the expression Cam angle B=(Cam angle/V)×ΔV=(80° CA/V)×(0V)=0° CA. That is, during the phase-retard mode, the gradient (the voltage difference) ΔV updated for every 10° crankangle is set to 0V/10° CA, and thus the difference (Cam angle B−Crank angle B=0° CA−10° CA) becomes −10° CA (per 10° crankangle), and the phase difference of camshaft 4 relative to crankshaft 1 also becomes −10° CA (per 10° crankangle). As a result, the cam phase angle becomes retarded by 10° CA (per 10° crankangle). As clearly shown in FIG. 10A, the phase-retard state is continuously detected for the time interval corresponding to the eight consecutive crank 10° CA pulses (containing the zero pulse signal output corresponding to the missing toothed portion), and thus the phase-retard angle of the VTC device becomes (−10° CA)×8=−80° CA.

As explained previously in reference to FIGS. 8-10B, according to the 1^{st} modified phase-angle detection method utilizing gradient ΔV (per 10° CA) of cam-angle sensor signal output V, it is possible to detect a relative-rotation phase difference between camshaft 4 and crankshaft 1 for every detection of crank 10° CA pulse, thus improving the accuracy of detection cam phase angle.

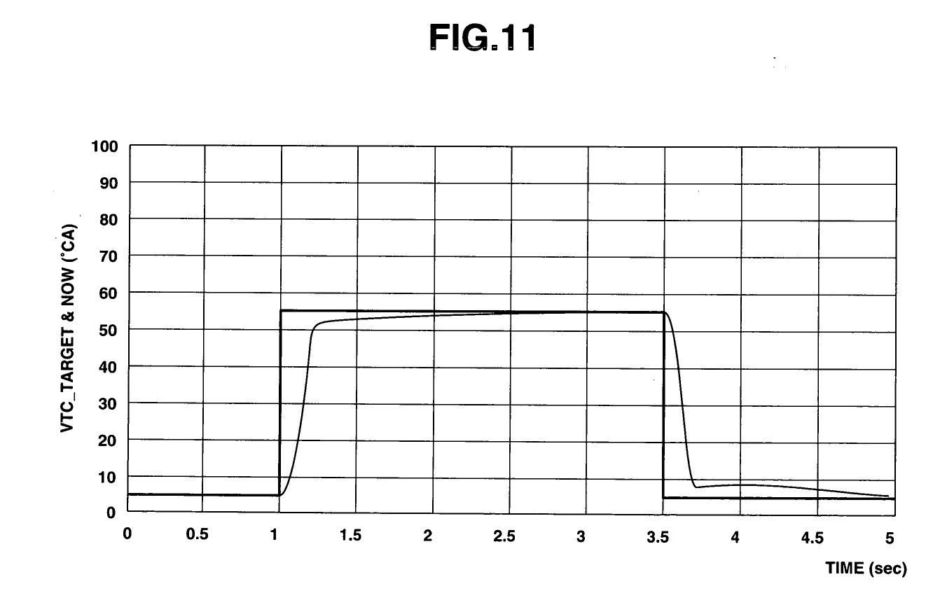

Referring now to FIG. 11, there is shown the step-response waveform obtained by the phase-angle detection method of FIG. 6 or by the 1^{st} modified phase-angle detection method of FIG. 8, during engine cranking at approximately 200 rpm. In FIG. 11, the rectangle indicated by the thick solid line corresponds to the shape of cam target 11 of cam-angle sensor 8, whereas the fine solid line indicates the actual phase angle of camshaft 4 to crankshaft 1. As can be appreciated from the step-response characteristic of FIG. 11, by the use of the improved phase-angle detection methods shown in FIGS. 6 and 8, the shape of cam target 11 and the actual waveform of cam phase angle are matched very well and substantially identical to each other. Therefore, each of the improved phase-angle detection methods shown in FIGS. 6 and 8 enables a more-precise phase-angle detection.

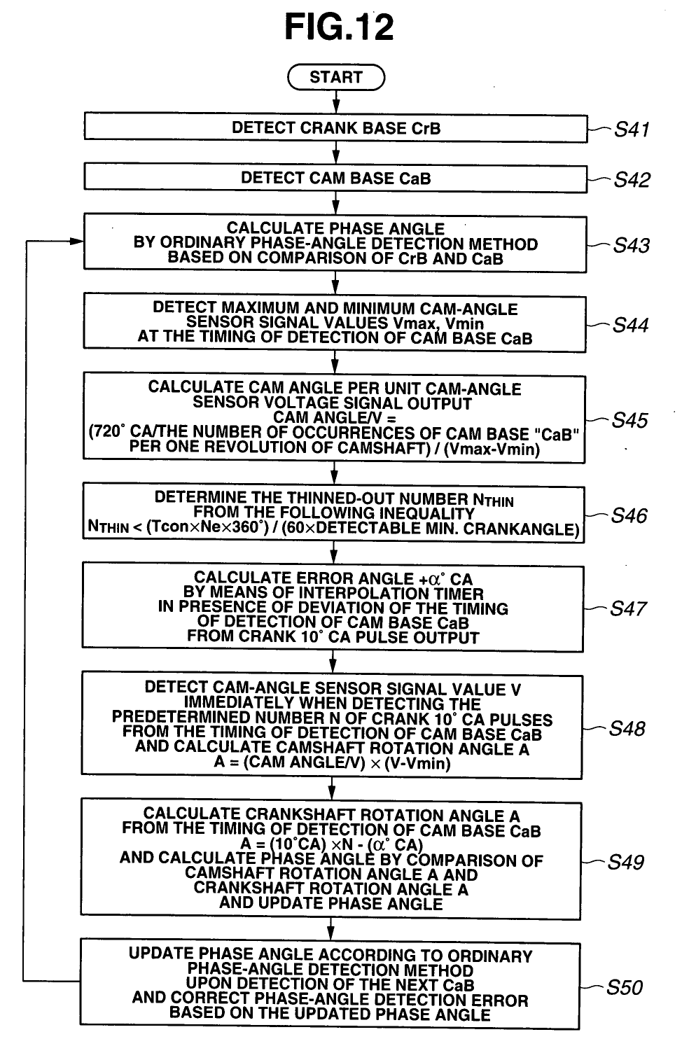

Referring now to FIG. 12, there is shown the 2^{nd} modified phase-angle detection routine. The 2^{nd} modified phase-angle detection routine of FIG. 12 is also executed as time-triggered interrupt routines to be triggered every predetermined sampling time intervals, such as 10 milliseconds. Basically, the 2^{nd} modified phase-angle detection routine of FIG. 12 is similar to the arithmetic and logic processing of FIG. 6. However, the 2^{nd} modified phase-angle detection routine of FIG. 12 somewhat differs from the routine of FIG. 6, in that thinned-out processing for the number of detection of crank 10° CA pulses generated from crank-angle sensor 7 is further executed through step S46. Steps S41-S45 and S47-S50 of the 2^{nd} modified routine of FIG. 12 are equal to respective steps S1-S3 and S6-S11 of the routine of FIG. 6. Only the different step S46 of FIG. 12 will be hereinafter described in detail with reference to the accompanying drawings, while detailed description of steps S41-S45 and S47-S50 will be omitted because the above description thereon seems to be self-explanatory.

At step S41, crank base CrB is detected. At step S42, cam base CaB is detected. At step S43, a cam phase angle (a relative-rotation phase difference of camshaft 4 to crankshaft 1) is calculated by way of an ordinary phase-angle detection method based on CaB-CrB comparison. At step S44, the processor of controller 6 detects maximum and minimum sensor signal values Vmax and Vmin (see FIG. 5) of the cam-angle sensor voltage signal output from cam-angle sensor 8 at the timing of detection of cam base CaB. At step S45, a camshaft rotation angle per a unit cam-angle sensor voltage signal output, is arithmetically calculated from the previously-discussed conversion expression, that is, (Cam angle/V)=(720° CA/the number of occurrences of cam base “CaB” per one revolution of camshaft)/(Vmax-Vmin).

At step S46, the thinned-out number N_{THIN} for the thinned-out processing is determined by the following inequality. That is, the highest integer, satisfying the following inequality, is determined as the thinned-out number N_{THIN}.

N_{THIN}<(Tcon×Ne×360°)/(60×(Detectable minimum crankangle)) where Tcon denotes a control cycle (i.e., a predetermined sampling time interval, such as 10 milliseconds), Ne denotes engine speed, and (Detectable minimum crankangle) is 10° CA in the control system of the embodiment.

For instance, assuming that engine speed Ne is 1000 rpm and control execution cycle Tcon is 10 milliseconds (i.e., 1/100 sec), the thinned-out number N_{THIN} is represented by the inequality N_{THIN}0<(( 1/100)×1000×360°)/(60×10°)=6. Thus, in the case of Ne=1000 rpm, positive integers satisfying the inequality N_{THIN}<6 becomes 5, 4, 3, 2, 1, and thus the maximum value of these integers is “5”. As a result, the thinned-out number N_{THIN} is determined as “5”. In contrast, assuming that engine speed Ne is 200 rpm (e.g., during cranking) and control execution cycle Tcon is 10 milliseconds (i.e., 1/100 sec), the thinned-out number N_{THIN} is represented by the inequality N_{THIN}<(( 1/100)×200×360°)/(60×10°)=1.2. Thus, in the case of Ne=200 rpm, a positive integer satisfying the inequality N_{THIN}<1.2 becomes 1, and as a result the thinned-out number N_{THIN} is determined as “1”. Therefore, the thinned-out number N_{THIN} for the thinned-out processing tends to increase, as engine speed Ne increases. More concretely, regarding the thinned-out processing for the number of detection of crank 10° CA pulses generated from crank-angle sensor 7, as previously discussed, at engine speed Ne of 1000 rpm, the thinned-out number N_{THIN} is determined or set as “5”. In this case, according to the thinned-out processing, controller 6 omits the operation of detection of five consecutive crank 10° CA pulses from the first detection of crank 10° CA pulse (e.g., the first pulse output) to the next detection of crank 10° CA pulse (e.g., the seventh pulse output). This is because, at engine speed Ne of 1000 rpm, the number of occurrences of 10° CA pulses is 600 per second, in other words, there is one 10° CA pulse output at 1/600 second (i.e., one pulse output at 1.6667 milliseconds). On the other hand, the control execution cycle is 10 milliseconds. As can be appreciated from comparison of the control execution cycle (10 milliseconds) to the frequency (1.6667 milliseconds at engine speed Ne=1000 rpm) of 10° CA pulse output, it is unnecessary to detect all of 10° CA pulses generated from crank-angle sensor 7. For the reasons discussed above, the thinned-out processing of step S46 is advantageous and effective to reduce the load on any electrical circuit of controller 6. In the control system of the embodiment, the thinned-out processing of step S46 of FIG. 12 is cyclically executed within a rotational-speed range of crankshaft 1, greater than or equal to a predetermined speed value.

In the same manner as steps S8-S10 of the routine of FIG. 6, steps S47-S49 of the 2^{nd} modified routine of FIG. 8 enables the cam-phase-angle detection method utilizing the “interpolation” timer. Thereafter, at step S50, when the next cam base CaB is detected, informational data concerning the phase difference (or the cam phase angle) is updated according to the ordinary cam-phase-angle detection method (that is, the phase-angle detection method based on CaB-CrB comparison). At the same time, a phase-angle detection error is corrected based on the updated phase angle. Thereafter, the routine returns from step S50 to step S43. A series of steps S44-S49, included in the 2^{nd} modified cam-phase-angle detection method including the thinned-out processing and utilizing the “interpolation” timer, are repeatedly executed, until the next cam base CaB is detected.

The previously-discussed predetermined number N (needed for steps S48-S49 of FIG. 12) of crank 10° CA pulses is obtained by the inequality 1≦N≦(720° CA/the number of occurrences of cam base “CaB” per one revolution of camshaft)/(10° CA)−1. In the shown embodiment, the number of occurrences of cam base “CaB” per one revolution of camshaft is “3”, and therefore the predetermined number N is set within the specified range of 1≦N≦23.

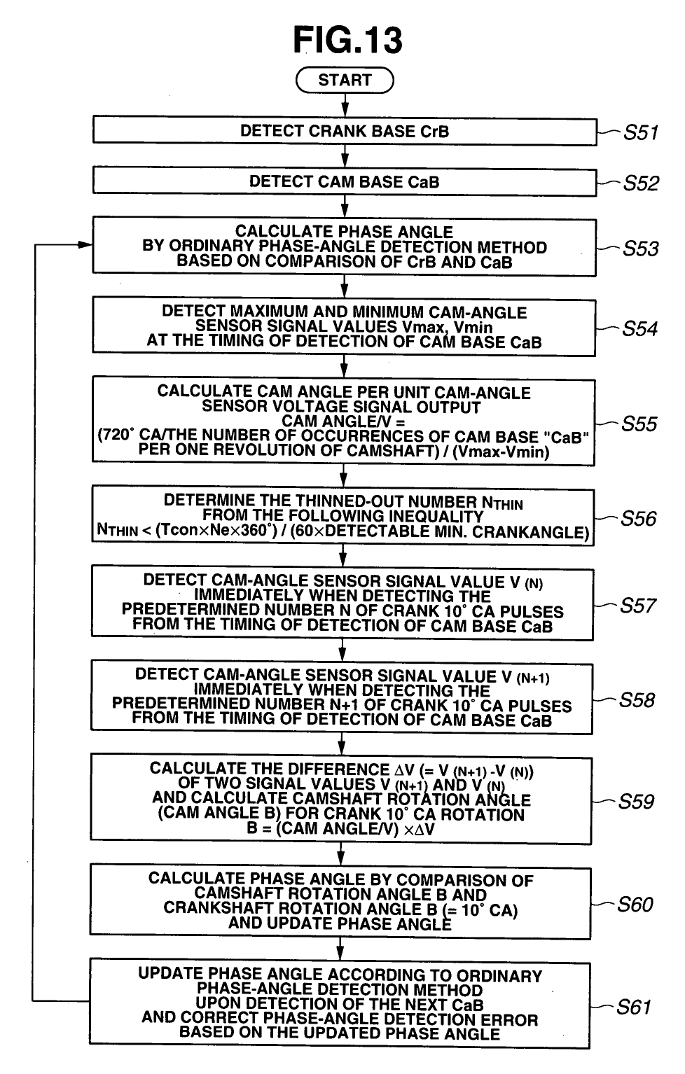

Referring now to FIG. 13, there is shown the 3^{rd} modified phase-angle detection routine. The 3^{rd} modified phase-angle detection routine of FIG. 13 is also executed as time-triggered interrupt routines to be triggered every predetermined sampling time intervals, such as 10 milliseconds. The 3^{rd} modified phase-angle detection routine of FIG. 13 is a combined routine of steps S41-S46 of FIG. 12 and steps S28-S32 of FIG. 8. Steps S51-S56 of the 3^{rd} modified routine of FIG. 13 are equal to respective steps S41-S45 of the routine of FIG. 12, whereas steps S57-S61 of the 3^{rd} modified routine of FIG. 13 are equal to respective steps S28-S32 of the routine of FIG. 8. Thus, detailed description of steps S51-S61 will be omitted because the above description thereon seems to be self-explanatory.

At step S51, crank base CrB is detected. At step S52, cam base CaB is detected. At step S53, a cam phase angle (a relative-rotation phase difference of camshaft 4 to crankshaft 1) is calculated by way of an ordinary phase-angle detection method based on CaB-CrB comparison. At step S54, the processor of controller 6 detects maximum and minimum sensor signal values Vmax and Vmin (see FIG. 5) of the cam-angle sensor voltage signal output from cam-angle sensor 8 at the timing of detection of cam base CaB. At step S55, a camshaft rotation angle per a unit cam-angle sensor voltage signal output, is arithmetically calculated from the previously-discussed conversion expression, that is, (Cam angle/V)=(720° CA/the number of occurrences of cam base “CaB” per one revolution of camshaft)/(Vmax-Vmin). At step S56, the thinned-out number N_{THIN} for the thinned-out processing for the number of detection of crank 10° CA pulses generated from crank-angle sensor 7 is determined by the inequality N_{THIN}<(Tcon×Ne×360°)/(60×(Detectable minimum crankangle CAmin)), where Tcon denotes a control execution cycle (i.e., a predetermined sampling time interval, such as 10 milliseconds), Ne denotes engine speed, and (Detectable minimum crankangle) is 10° CA in the control system of the embodiment.

Thereafter, at step S57 of FIG. 13, immediately when detecting the predetermined number N of crank 10° CA pulses from the timing of detection of cam base CaB (detected through step S52), a cam-angle sensor signal value V_{(N)} is detected. At step S58, immediately when detecting the predetermined number N+1 of crank 10° CA pulses from the timing of detection of cam base CaB (detected through step S52), a cam-angle sensor signal value V_{(N+1)} is detected. At step S59, the difference ΔV (=V_{(N+1)}−V_{(N)}) of these two signal values V_{(N+1)} and V_{(N)} is arithmetically calculated, and additionally a cam angle B for crank 10° CA rotation is arithmetically calculated from the expression Cam angle B=(Cam angle/V)×(V_{(N+1)}−V_{(N)})=(Cam angle/V)×ΔV. At step S60, a rotation angle of crankshaft 1 (a crank angle B) from the timing of detection of the consecutive crank 10° CA pulses of the predetermined number N to the timing of detection of the consecutive crank 10° CA pulses of the predetermined number N+l is always set to 10° CA, because of (N+1)−N=1. Additionally, at step S60, a phase angle (i.e., a phase difference of camshaft 4 relative to crankshaft 1) is calculated by comparing the crank angle B {=10° CA} to the calculated cam angle B (=(Cam angle/V)×ΔV)) obtained through step S59, that is, by subtracting the crank angle B {=10° CA} from the calculated cam angle B (=(Cam angle/V)×ΔV)). Thereafter, informational data concerning a phase difference (or a cam phase angle) is updated by the newly calculated phase angle. At step S61, when the next cam base CaB is detected, informational data concerning the phase difference (or the cam phase angle) is updated according to the ordinary cam-phase-angle detection method (that is, the phase-angle detection method based on CaB-CrB comparison). At the same time, a phase-angle detection error is corrected based on the updated phase angle. Thereafter, the routine returns from step S61 to step S53. A series of steps S54-S60, included in the combined cam-phase-angle detection method including the thinned-out processing and utilizing gradient ΔV (per 10° CA) of cam-angle sensor signal output V, are repeatedly executed, until the next cam base CaB is detected.

The previously-discussed predetermined number N (needed for steps S57-S58 of FIG. 13) of crank 10° CA pulses is obtained by the inequality 1≦N≦(720° CA/the number of occurrences of cam base “CaB” per one revolution of camshaft)/(10° CA)−1. In the shown embodiment, the number of occurrences of cam base “CaB” per one revolution of camshaft is “3”, and therefore the predetermined number N is set within the specified range of 1≦N≦23.

Referring now to FIG. 14, there is shown the 4^{th} modified phase-angle detection routine. The 4^{th} modified phase-angle detection routine of FIG. 14 is also executed as time-triggered interrupt routines to be triggered every predetermined sampling time intervals, such as 10 milliseconds. The previously-described phase-angle detection methods shown in FIGS. 6, 8, 12, and 13 are designed and configured under a prerequisite that the sensor signal value V generated from cam-angle sensor 8 changes depending on a change in engine speed Ne. In contrast, the 4th modified phase-angle detection routine (the 4th modified phase-angle detection method) of FIG. 14 utilizes a laser displacement meter whose gap detection signal output is unaffected by a change in engine speed Ne (that is, a passage time of cam target 11). Such a laser displacement meter can produce a constant signal output, regardless of fluctuations in engine speed Ne (rotation speed of crankshaft 1). Basically, the 4^{th} modified routine of FIG. 14 is similar to the 1^{st} modified phase-angle detection method of FIG. 8. By the use of a laser displacement meter as cam-angle sensor 8, there is no necessity for comparison between crank base CrB and cam base CaB. Thus, the 4^{th} modified routine of FIG. 14 is constructed only by steps S71-S77 corresponding to respective steps S22 and S26-S31 of the routine of FIG. 8, by cancellation of steps S21, S23-S25 and S32 of the routine of FIG. 8.

At step S71, cam base CaB is detected based on the signal from the laser displacement meter (serving as cam-angle sensor 8). At step S72, the processor of controller 6 detects maximum and minimum cam-angle sensor signal values Vmax and Vmin (see FIG. 5) from the laser displacement meter (serving as cam-angle sensor 8) at the timing of detection of cam base CaB, which cam base CaB has been detected through step S71. Steps S73-S77 of the 4th modified routine of FIG. 14 are identical to steps S27-S31 of the 1^{st} modified routine of FIG. 8, utilizing gradient ΔV (per 10° CA) of cam-angle sensor signal output V. That is, at step S73, a camshaft rotation angle per a unit cam-angle sensor voltage signal output, is arithmetically calculated from the conversion expression (Cam angle/V)=(720° CA/the number of occurrences of cam base “CaB” per one revolution of camshaft)/(Vmax−Vmin). At step S74, immediately when detecting the predetermined number N of crank 10° CA pulses from the timing of detection of cam base CaB, a cam-angle sensor signal value V_{(N)} is detected. At this stage, the cam-angle sensor voltage signal output V_{(N)} is merely detected and memorized (see FIG. 9). At step S75, immediately when detecting the predetermined number N+1 of crank 10° CA pulses from the timing of detection of cam base CaB, a cam-angle sensor signal value V_{(N+1)} is detected. At step S76, the difference ΔV (=V_{(N+1)}−V_{(N)}) of these two signal values V_{(N+1)} and V_{(N)} is arithmetically calculated, and additionally a camshaft rotation angle (a cam angle B) for crank 10° CA rotation is arithmetically calculated from the expression Cam angle B=(Cam angle/V)×(V_{(N+1)}−V_{(N)})=(Cam angle/V)×ΔV. At step S77, a rotation angle of crankshaft 1 (a crank angle B) from the timing of detection of the consecutive crank 10° CA pulses of the predetermined number N to the timing of detection of the consecutive crank 10° CA pulses of the predetermined number N+1 is always set to 10° CA, because of (N+1)−N=1. Additionally, at step S77, a phase angle (i.e., a phase difference of camshaft 4 relative to crankshaft 1) is calculated by comparing the crank angle B {=10° CA} to the calculated cam angle B (=(Cam angle/V)×ΔV)) obtained through step S76, that is, by subtracting the crank angle B {=10° CA) from the calculated cam angle B (=(Cam angle/V)×ΔV)). The comparison result (the computational result) denoted by a positive sign “+”, i.e., the positive phase difference of camshaft 4 to crankshaft 1 means a phase advance, whereas the comparison result denoted by a minus sign “−”, i.e., the negative phase difference of camshaft 4 to crankshaft 1 means a phase retard. Informational data concerning a phase difference (or a cam phase angle) is updated by the newly calculated phase angle.

The previously-discussed predetermined number N (needed for steps S74-S75 of FIG. 14) of crank 10° CA pulses is obtained by the inequality 1≦N≦(720° CA/the number of occurrences of cam base “CaB” per one revolution of camshaft)/(10° CA)−1. In the shown embodiment, the number of occurrences of cam base “CaB” per one revolution of camshaft is “3”, and therefore the predetermined number N is set within the specified range of 1≦N≦23.

In the phase angle detection device of the embodiment, cam target 11 of cam-angle sensor 8 is configured to have three 1^{st} detecting sections 13a, 13a, 13a and three 2^{nd} detecting sections 13b, 13b, 13b. In lieu thereof, cam target 11 may be configured to have only one 1^{st} detecting section 13a and only one 2^{nd} detecting section 13b. Alternatively, cam target 11 may be configured to have circumferentially equidistant-spaced two target portions 13, each having 1^{st} and 2^{nd} detecting sections 13a and 13b. In the shown embodiment, 1^{st} detecting section 13a has a continuous arc-shaped curve. It will be appreciated that the shape of 1^{st} detecting section 13a is not limited to the particular embodiments shown and described herein, but that, if the shape of 1^{st} detecting section 13a is a continuous shape, any kind of shape may be used.

Although the phase angle detection device of the embodiment is exemplified in a variable valve timing control (VTC) system of an internal combustion engine, the application of the phase angle detection device of the embodiment is not limited to only the VTC system. The phase angle detection device of the embodiment can be applied to any kind of apparatus/device having two rotation axes, one being a drive shaft and the other being a driven shaft, for the purpose of detecting a relative-rotation phase difference of the driven shaft to the drive shaft.

In the shown embodiment, the rotation angle of crankshaft 1 is output from crank-angle detecting element 10 in the form of a pulse signal, exactly, a crank 10° CA pulse signal serving as a reference (REF) of a minimum detection cycle. In lieu thereof, crank-angle sensor 7 may be configured as an analogue-signal generator similar to cam-angle sensor 8 as shown in FIG. 4.

The entire contents of Japanese Patent Application No. 2006-198828 (filed Jul. 21, 2006) are incorporated herein by reference.

While the foregoing is a description of the preferred embodiments carried out the invention, it will be understood that the invention is not limited to the particular embodiments shown and described herein, but that various changes and modifications may be made without departing from the scope or spirit of this invention as defined by the following claims.

What is claimed is:

1. A phase angle detection device comprising:
a drive-shaft angle detecting element configured to detect a rotational position of a drive shaft through a predetermined drive-shaft target;
a driven-shaft target fixedly connected to a driven shaft driven by the drive shaft, and having a first detecting section whose detected position continuously changes and at least one second detecting section whose detected position discontinuously changes, the second detecting section being formed at one end of the first detecting section; and
a driven-shaft angle detecting element configured to detect a displacement of the driven-shaft target,
wherein the phase angle detection device detects a rotation angle of the driven shaft based on an output signal from the driven-shaft angle detecting element, and detects a rotation angle of the drive shaft based on an output signal from the drive-shaft angle detecting element, and detects a phase angle of the driven shaft relative to the drive shaft based on the detected rotation angle of the driven shaft and the detected rotation angle of the drive shaft.

2. The phase angle detection device as claimed in claim 1, wherein:
the driven-shaft target is configured to protrude in a radial direction of the driven shaft, and the driven-shaft angle detecting element is arranged in the radial direction of the driven shaft.

3. The phase angle detection device as claimed in claim 1, wherein:
the driven-shaft target is configured to be installed on an axial end of the driven shaft, and the driven-shaft angle detecting element is arranged in an axial direction of the driven shaft.

4. The phase angle detection device as claimed in claim 1, wherein:
the phase angle detection device is configured to arithmetically calculate the phase angle of the driven shaft relative to the drive shaft detected based on the detected rotation angle of the driven shaft and the detected rotation angle of the drive shaft.

5. The phase angle detection device as claimed in claim 1, wherein:
the rotation angle of the drive shaft is output from the drive-shaft angle detecting element as an analogue signal.

6. The phase angle detection device as claimed in claim 1, wherein:
the rotation angle of the drive shaft is output from the drive-shaft angle detecting element as a pulse signal.

7. The phase angle detection device as claimed in claim 6, wherein:
a thinned-out processing is made to the pulse signal of a predetermined timing, outputted from the drive-shaft angle detecting element within a speed range above a predetermined speed of the drive shaft.

8. A phase angle detection device comprising:
a drive-shaft angle detecting element configured to detect a rotational position of a drive shaft through a predetermined drive-shaft target;
a driven-shaft target fixedly connected to a driven shaft driven by the drive shaft, and having a first detecting section whose detected position continuously changes and at least one second detecting section whose detected position discontinuously changes, the second detecting section being formed at one end of the first detecting section;
a driven-shaft angle detecting element configured to detect a displacement of the driven-shaft target; and
a controller configured to detect a rotation angle of the driven shaft based on an output signal from the driven-shaft angle detecting element, and to detect a rotation angle of the drive shaft based on an output signal from the drive-shaft angle detecting element, and to detect a phase angle of the driven shaft relative to the drive shaft based on the detected rotation angle of the driven shaft and the detected rotation angle of the drive shaft.

9. An internal combustion engine valve timing control apparatus employing a phase-change mechanism for variably adjusting engine valve timing by changing a relative-rotation phase between a camshaft and a crankshaft depending on an engine operating condition, and a controller configured to detect a relative-rotation phase difference between the camshaft and the crankshaft and to output a drive signal based on the detected phase difference to the phase-change mechanism, the valve timing control apparatus comprising:
a crank-angle detecting element configured to detect a rotational position of the crankshaft through a predetermined crank target;
a cam target fixedly connected to the camshaft driven by the crankshaft, and having a first detecting section whose detected position continuously changes and at least one second detecting section whose detected position discontinuously changes, the second detecting section being formed at one end of the first detecting section; and
a cam-angle detecting element configured to detect a displacement of the cam target,
wherein the controller is configured to detect a rotation angle of the camshaft based on an output signal from the cam-angle detecting element, and to detect a rotation angle of the crankshaft based on an output signal from the crank-angle detecting element, and to detect a phase angle of the camshaft relative to the crankshaft based on the detected rotation angle of the camshaft and the detected rotation angle of the crankshaft.

10. An internal combustion engine valve timing control apparatus comprising:
a crank-angle detecting element configured to detect a rotational position of a crankshaft through a predetermined crank target;
a cam target fixedly connected to a camshaft driven by the crankshaft, and having a first detecting section whose detected position continuously changes and at least one second detecting section whose detected position discontinuously changes, the second detecting section being formed at one end of the first detecting section;
a cam-angle detecting element configured to detect a displacement of the cam target;
a controller configured to detect a rotation angle of the camshaft based on an output signal from the cam-angle detecting element, and to detect a rotation angle of the crankshaft based on an output signal from the crank-angle detecting element, and to detect a phase angle of the camshaft relative to the crankshaft based on the detected rotation angle of the camshaft and the detected rotation angle of the crankshaft; and
a phase-change mechanism for changing the phase angle of the camshaft relative to the crankshaft in response to a control signal generated from the controller and determined based on the detected phase angle.

11. The phase angle detection device as claimed in claim 10, wherein the controller is further programmed for:
(a) detecting a cam-angle base position, based on the output signal generated from the cam-angle detecting element due to the second detecting section; and
(b) detecting an intermediate rotation angle of the camshaft between two consecutively-detected cam-angle base positions by interpolation, based on the output signal generated from the cam-angle detecting element due to the first detecting section.

12. The phase angle detection device as claimed in claim 10, wherein the controller is further programmed for:
(a) detecting a cam-angle base position, based on the output signal generated from the cam-angle detecting element due to the second detecting section; and
(b) detecting an intermediate rotation angle of the camshaft between two consecutively-detected cam-angle base positions by a rate of change, based on the output signal generated from the cam-angle detecting element due to the first detecting section.

13. The phase angle detection device as claimed in claim 10, wherein:
the crank-angle detecting element comprises a pulse generator; and
the controller is further programmed for:
executing a thinned-out processing to a pulse signal of a predetermined timing, outputted from the crank-angle detecting element within a speed range above a predetermined speed of the crankshaft.

14. The phase angle detection device as claimed in claim 13, wherein the controller is further programmed for:
calculating a thinned-out number N_{THIN} for the thinned-out processing for detection of pulses outputted from the crank-angle detecting element by an inequality N_{THIN}<(Tcon×Ne×360°)/(60×CAmin), where Tcon denotes a control execution cycle, Ne denotes an engine speed, and CAmin denotes a detectable minimum crankangle; and
determining a highest integer, satisfying the inequality, as the thinned-out number.

15. The phase angle detection device as claimed in claim 14, wherein the controller is further programmed for:
cyclically thinning out detection of consecutively-generated pulses corresponding to the determined thinned-out number.
